(19) United States
(12) Patent Application Publication
(10) Pub. No.: US 2014/0369037 A1
(43) Pub. Date: Dec. 18, 2014

(54) Omnidirectional Lamp

(71) Applicant: Everlight Electronics Co., Ltd., New Taipei City (TW)

(72) Inventors: Feng-Ting Hsu, New Taipei City (TW); Chien-Chang Pei, New Taipei City (TW); Li-Li Ho, New Taipei City (TW)

(73) Assignee: Everlight Electronics Co., Ltd., New Taipei City (TW)

(21) Appl. No.: 14/284,807

(22) Filed: May 22, 2014

Related U.S. Application Data
(60) Provisional application No. 61/836,409, filed on Jun. 18, 2013.

(51) Int. Cl. F21K 99/00; F21V 29/00

(52) U.S. Cl. CPC F21K 9/135; F21K 9/50; F21V 29/2206; F21Y 2101/02
USPC 362/235; 362/249.01; 362/249.02

(57) ABSTRACT

Various examples of a lamp that produces omnidirectional light are described. The lamp may include a light-emission module. The light-emission module may include a substrate having a first primary surface. The first primary surface of the substrate may define a first horizontal plane that is substantially perpendicular to a longitudinal axis of the lamp. The light-emission module may also include at least one first light source and at least one second light source disposed on the first primary surface of the substrate. Each of the at least one second light source may include a light-emitting surface at an individually adjustable angle with respect to the first horizontal plane.

### CROSS REFERENCE TO RELATED PATENT APPLICATION

The present disclosure is a non-provisional application claiming the priority benefit of U.S. Patent Application No. 61/836,409, filed on 18 Jun. 2013, which is incorporated by reference in its entirety.

### TECHNICAL FIELD

The present disclosure relates to luminaires and, more particularly, to lamps that can replace incandescent lamps.

### BACKGROUND

The ENERGY STAR program is a U.S. Environmental Protection Agency voluntary program that aims to help businesses and individuals save money and protect the climate through superior energy efficiency. Among other things, the ENERGY STAR program defines the specification for bulb light intensity distribution, according to which commercially available products are divided into two main categories depending on whether they meet the specification or not. Given the nature of direct light emission by light-emitting diodes (LEDs), additional mechanism is often necessary to change the direction in which the emitted light travels in order to achieve uniform distribution of light. In particular, although relatively higher light efficiency may be achieved by distributing light with certain mechanism, one common issue is the undesirable visual effect of bright and dark spots on the lampshade due to non-uniform distribution of light.

As LED lamps become increasingly popular, more and more conventional lamps, such as incandescent light bulbs, are replaced by LED lamps in a variety of applications. There is, however, a need for a new LED lamp that not only meets the requirements of the ENERGY STAR program and maintains a relatively high light efficiency, but also achieves an improved visual effect on the lampshade.

### SUMMARY

The present disclosure describes various embodiments of a lamp, such as a 40-Watt LED lamp for example, that produces omnidirectional light. Embodiments of a lamp of the present disclosure meet the requirements of the ENERGY STAR program with respect to intensity and uniformity of light emitted by A60 light bulbs, and comply with American National Standards Institute (ANSI) requirements at least in terms of size and form factor. Moreover, as no excessive optical components are used in the lamp of the present disclosure, lower optical loss and highly efficient energy utilization can be achieved. Furthermore, optimal visual effect can be achieved by the lamp of the present disclosure whether powered on or powered off.

In one aspect, a lamp may include a light-emission module which may include a substrate, at least one first light source and at least one second light source. The substrate may include a first primary surface defining a first horizontal plane that is substantially perpendicular to a longitudinal axis of the lamp. The at least one first light source and the at least one second light source may be disposed on the first primary surface of the substrate. The at least one second light source may include a light-emitting surface at an individually adjustable angle with respect to the first horizontal plane.

In some embodiments, the angle of the light-emitting surface of the at least one second light source may be approximately between 120 and 150 degrees or approximately 90 degrees with respect to the first horizontal plane.

In some embodiments, the angle of the light-emitting surface of the at least one first light source may be non-adjustable and may be approximately 0 degree with respect to the first horizontal plane.

In some embodiments, a ratio of a number of the at least one first light source to a number of the at least one second light source may be adjustable, and may be in a range between 0.3 and 0.6 approximately.

In some embodiments, the substrate may further include a second primary surface opposite to the first primary surface and defining a second horizontal plane that is substantially perpendicular to the longitudinal axis of the lamp. The light-emission module may further include at least one third light source disposed on the second primary surface of the substrate. The at least one third light source may include a light-emitting surface at an individually adjustable angle with respect to the second horizontal plane.

In some embodiments, one or more of the at least one first light source and the at least one second light source may include a light-emitting diode (LED).

In some embodiments, the lamp may further include a heat-dissipation module which may include a finned portion and a platform portion protruding from the finned portion along the longitudinal axis of the lamp. The platform portion may include a mounting surface on which a second primary surface of the substrate of the light-emission module opposite to the first primary surface may be mounted.

In some embodiments, a height of the platform portion of the heat-dissipation module between the finned portion and the mounting surface may be approximately between 10 and 30 mm.

In some embodiments, the lamp may further include a light-transmissive module, a drive circuit module and a power connection module. The light-transmissive module may be disposed on a first end of the heat-dissipation module to contain the light-emission module therein. The light-transmissive module may be configured to provide a light diffusion effect for light emitted by the light-emission module. The drive circuit module may be coupled to a second end of the heat-dissipation module opposite to the first end thereof. The drive circuit module may be configured to convert an AC electricity to a DC electricity to power the light-emission module. The power connection module may function as a base of the lamp and may be coupled to the drive circuit module. The power connection module may be configured to receive the AC electricity from an external power supply.

In some embodiments, light emitted by the light-emission module may be compliant with requirements of ENERGY STAR program with respect to intensity and uniformity of light emitted by an A60 light bulb. The lamp may be compliant with American National Standards Institute (ANSI) requirements at least in terms of size and form factor.

In another aspect, a lamp may include a light-emission module which may include a substrate, at least one first light source and at least one second light source. The substrate may include a first primary surface and a second primary surface opposite to the first primary surface. The first primary surface of the substrate may define a first horizontal plane that is substantially perpendicular to a longitudinal axis of the lamp. The second primary surface of the substrate may define a second horizontal plane that is substantially perpendicular to the longitudinal axis of the lamp. The at least one first light source may be disposed on the first primary surface of the substrate, and may include a light-emitting surface at a non-adjustable angle with respect to the first horizontal plane. The at least one second light source may be disposed on the second primary surface of the substrate, and may include a light-emitting surface at an individually adjustable angle with respect to the second horizontal plane. The angle of the light-emitting surface of the at least one second light source may be greater than 0 degree with respect to the second horizontal plane.

In some embodiments, a quantity of the at least one first light source may be six, and a quantity of the at least one second light source may be eighteen.

In some embodiments, the light-emission module may further include at least one third light source disposed on the first primary surface of the substrate and having a light-emitting surface at an individually adjustable angle with respect to the first horizontal plane.

In some embodiments, the lamp may further include a heat-dissipation module which may include a finned portion and a platform portion protruding from the finned portion along the longitudinal axis of the lamp. The platform portion may include a mounting surface on which the second primary surface of the substrate of the light-emission module is mounted. A height of the platform portion of the heat-dissipation module between the finned portion and the mounting surface may be approximately between 10 and 30 mm.

In some embodiments, the substrate may include a first circuit board and a second circuit board. The first circuit board may include the first primary surface on which the at least one first light source are disposed. The second circuit board may include the second primary surface on which the at least one second light source are disposed. The first and second circuit boards may be electrically coupled to each other.

In yet another aspect, a lamp may include a light-emission module and a heat-dissipation module.

The light-emission module may include a substrate, at least one first light source and at least one second light source. The substrate may include a first primary surface and a second primary surface opposite to the first primary surface. The first primary surface of the substrate may define a first horizontal plane that is substantially perpendicular to a longitudinal axis of the lamp. The at least one first light source may be disposed on the first primary surface of the substrate. The at least one first light source may include a light-emitting surface at an individually adjustable angle with respect to the first horizontal plane. The at least one second light source may be disposed on the second primary surface of the substrate. The second primary surface of the substrate may define a second horizontal plane that is substantially perpendicular to the longitudinal axis of the lamp. The at least one second light source may include a light-emitting surface at an individually adjustable angle with respect to the second horizontal plane.

The heat-dissipation module may include a finned portion and a platform portion protruding from the finned portion along the longitudinal axis of the lamp. The platform portion may include a mounting surface on which the second primary surface of the substrate of the light-emission module is mounted.

In some embodiments, the substrate may include a first circuit board and a second circuit board. The first circuit board may include the first primary surface on which the at least one first light source is disposed. The second circuit board may include the second primary surface on which the at least one second light source is disposed. The first and second circuit boards may be electrically coupled to each other.

In some embodiments, the angle of the light-emitting surface of the at least one first light source may be approximately 0 degree with respect to the first horizontal plane. The angle of the light-emitting surface of the at least one second light source may be approximately between 30 and 55 degrees with respect to the second horizontal plane.

In some embodiments, the lamp may further include a light-transmissive module, a drive circuit module and a power connection module. The light-transmissive module may be disposed on a first end of the heat-dissipation module to contain the light-emission module therein. The light-transmissive module may be configured to provide a light diffusion effect for light emitted by the light-emission module. The drive circuit module may be coupled to a second end of the heat-dissipation module opposite to the first end thereof. The drive circuit module may be configured to convert an AC electricity to a DC electricity to power the light-emission module. The power connection module may function as a base of the lamp and may be coupled to the drive circuit module. The power connection module may be configured to receive the AC electricity from an external power supply. A height of the platform portion of the heat-dissipation module between the finned portion and the mounting surface may be approximately between 10 and 30 mm.

In some embodiments, at least one of the light sources may include an LED. Light emitted by the light-emission module may be compliant with requirements of ENERGY STAR program with respect to intensity and uniformity of light emitted by an A60 light bulb. The lamp may be compliant with ANSI requirements at least in terms of size and form factor.

This summary is provided to introduce concepts relating to an omnidirectional lamp. Some embodiments of the electronic percussion instrument are further described below in the detailed description. This summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is an exploded view of an omnidirectional lamp in accordance with an embodiment of the present disclosure.

FIG. 2 is an embodiment of a light-emission module of the omnidirectional lamp of FIG. 1.

FIG. 3 highlights certain features of the omnidirectional lamp of FIG. 1.

FIG. 4 highlights certain other features of the omnidirectional lamp of FIG. 1.

FIG. 5 highlights an approach to coupling light sources to a substrate of the omnidirectional lamp of FIG. 1.

FIG. 6 is a diagram showing various views of the omnidirectional lamp of FIG. 1.

FIG. 7 is an exploded view of an omnidirectional lamp in accordance with another embodiment of the present disclosure.

FIG. 8 is an embodiment of a light-emission module of the omnidirectional lamp of FIG. 7.

FIG. 9 is a diagram showing various views of the omnidirectional lamp of FIG. 7.

### DETAILED DESCRIPTION OF DISCLOSED EMBODIMENTS

### Overview

A lamp according to various embodiments of the present disclosure utilizes a novel and non-obvious light-emission module. As dark areas tend to appear when a lamp is viewed from a side thereof, the light-emission module of the omnidirectional lamp according to the present disclosure is configured with one or more light sources, e.g., LEDs, each of which having a light-emitting surface at an individually adjustable angle with respect to a horizontal plane that is perpendicular to a longitudinal axis of the lamp. The horizontal plane may be defined by a surface of a substrate on which the one or more light sources are disposed. The angle between the light-emitting surface of each of the one or more light sources and the horizontal plane may be individually adjustable and may be, for example, 150 degrees, 135 degrees, 125 degrees, 120 degrees, 90 degrees, 45 degrees or 0 degree. The one or more light sources may be disposed on a top surface or a bottom surface of the substrate. The light-emission module may further include additional light sources, e.g., LEDs, each of which having a light-emitting surface substantially parallel with the horizontal plane. The light sources may be disposed on both the top and bottom surfaces of the substrate.

Some highlights of the features of the lamp include, but are not limited to the following:
1. The angle between the light-emitting surface of one or more light sources of the light-emission module and the horizontal plane is adjustable. By adjusting the angle(s), various angles of light flux of the lamp can be distributed to meet ENERGY STAR requirements.
2. A ratio of the number of light sources that emit light in a general direction toward respective sides of the lamp and the number of light sources that emit light in a general direction perpendicular to the horizontal plane and parallel to the longitudinal axis of the lamp (e.g., in the up direction) is adjustable so that ENERGY STAR requirements can be met.
3. The light sources are disposed higher than the heat-dissipation module of the lamp, which has a special shape, by at least a predefined distance to minimize blocking of the emitted light by the heat-dissipation module so as to meet ENERGY STAR requirements and to avoid a phenomenon of relatively weaker downward illumination.
4. A distance between the light sources of the light-emission module and a light-transmissive module (e.g., lampshade or lens) is kept to be no less than a minimum distance.

### Exemplary Designs

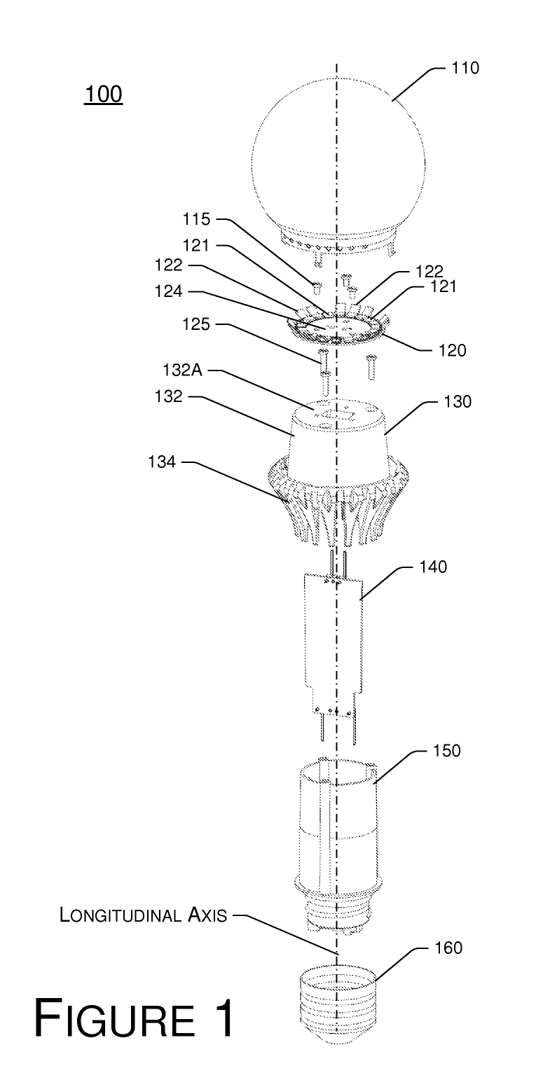

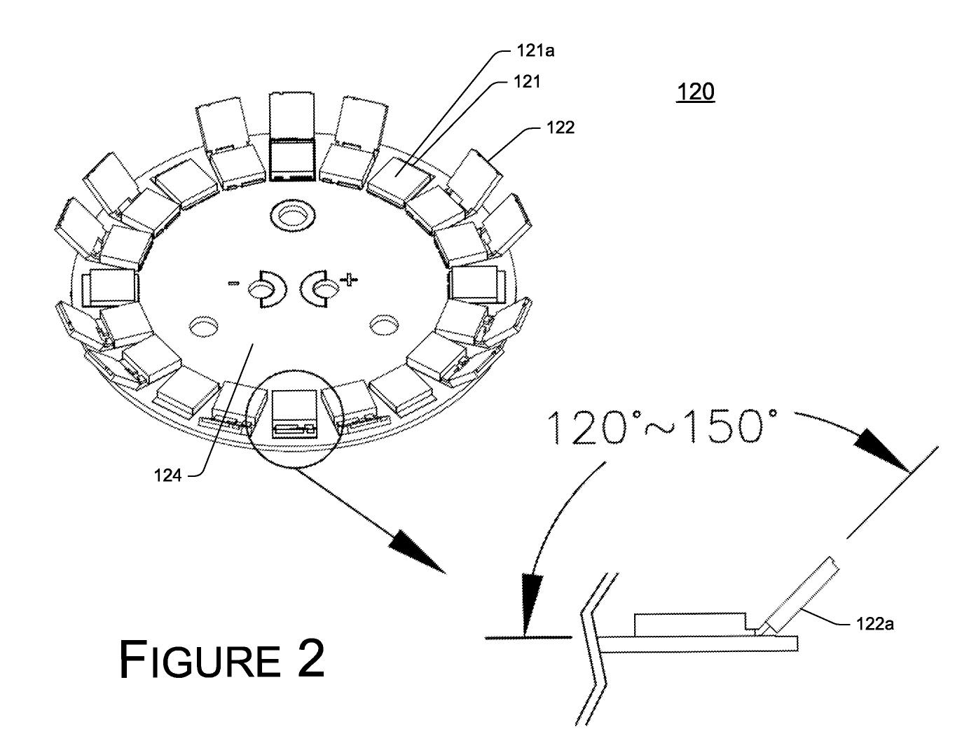

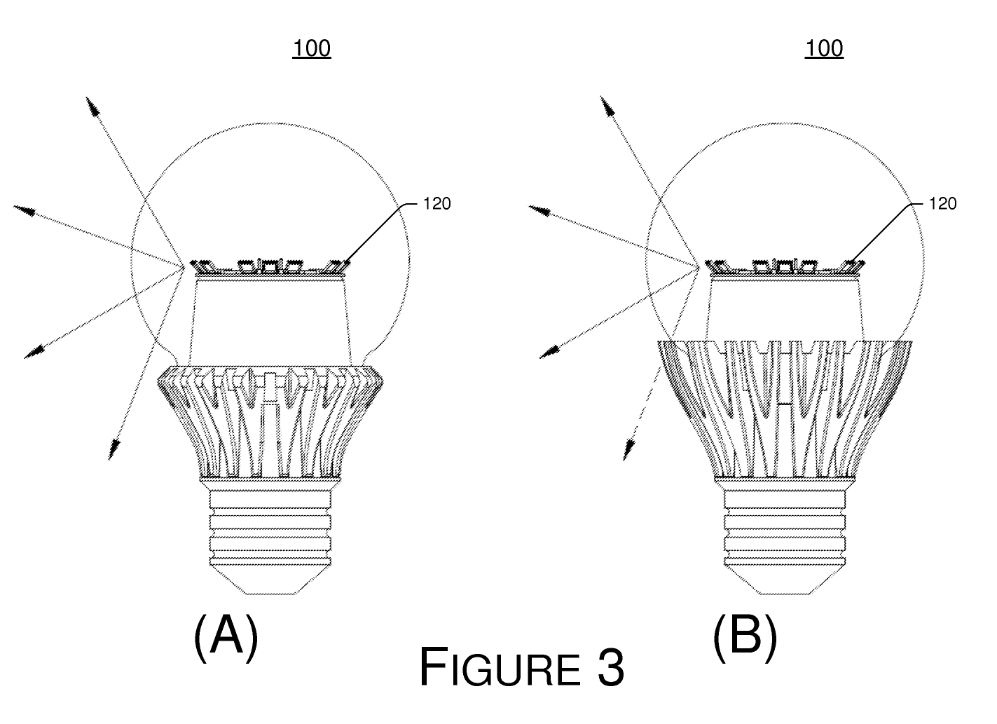

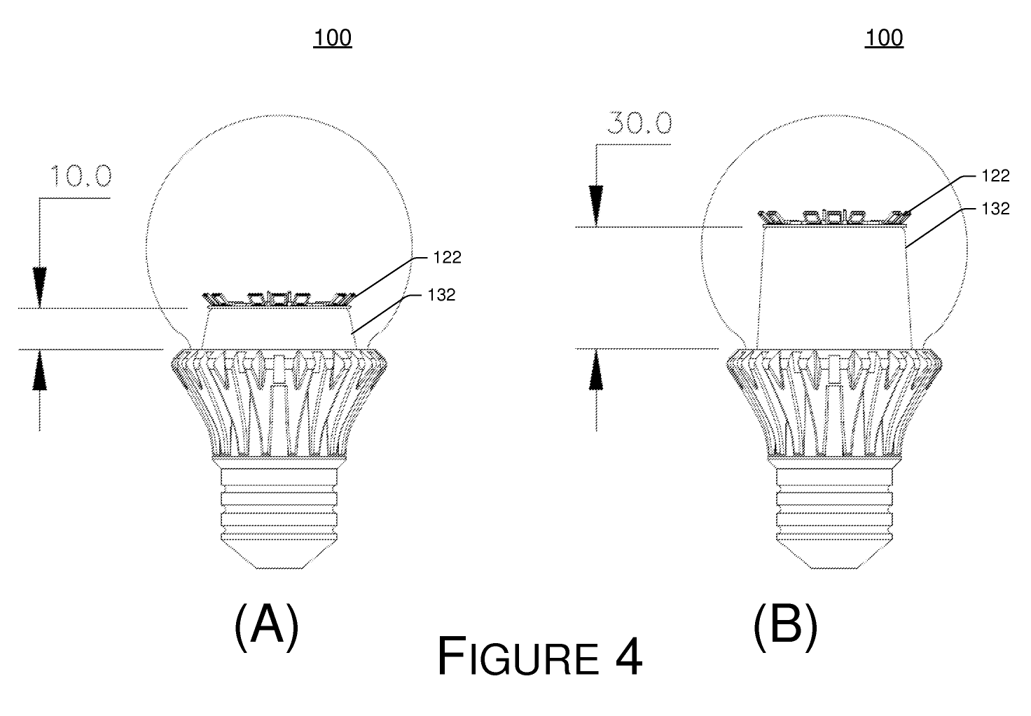

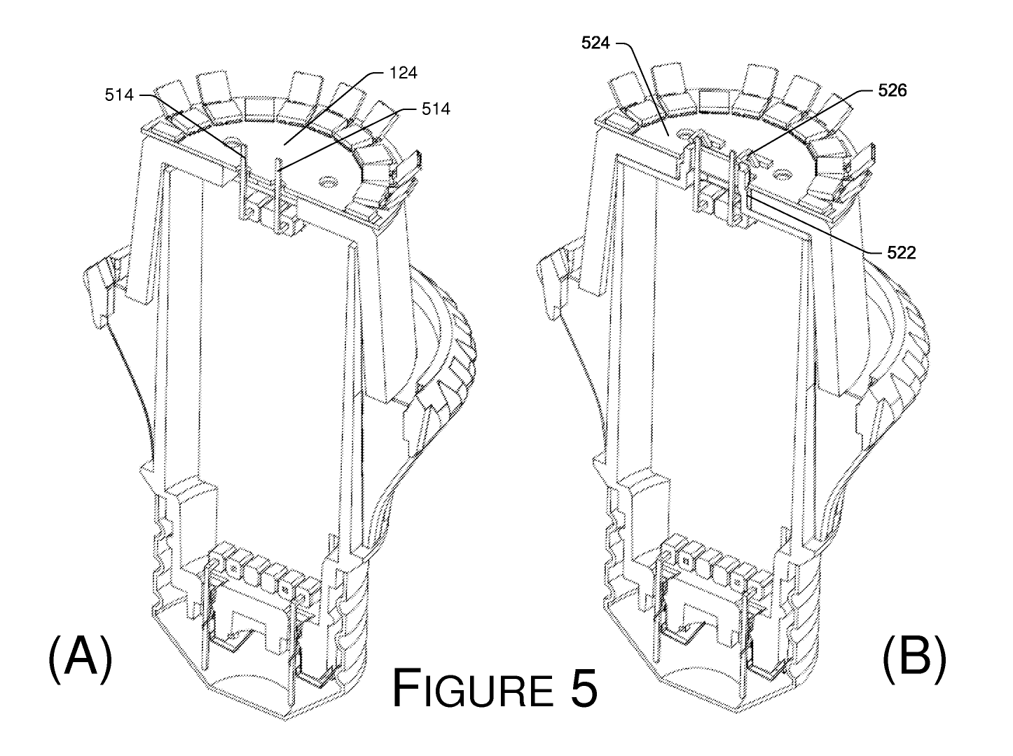

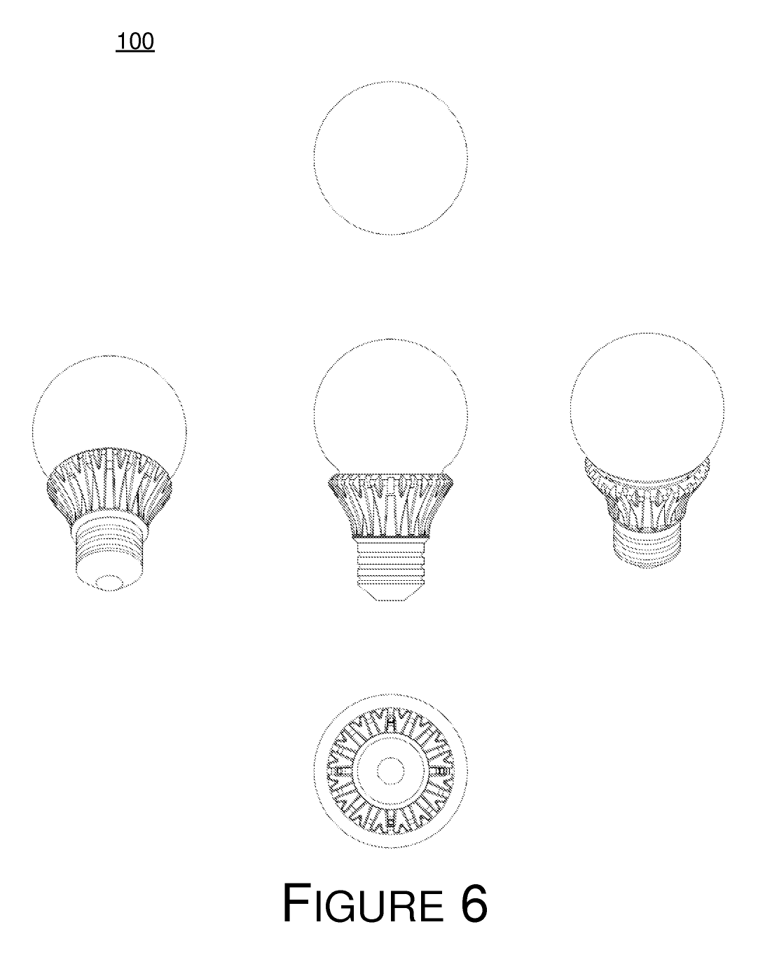

FIG. 1 is an exploded view of an omnidirectional lamp 100 in accordance with an embodiment of the present disclosure. FIG. 2 is an embodiment of a light-emission module of the omnidirectional lamp 100. FIG. 3 highlights certain features of the omnidirectional lamp 100. FIG. 4 highlights certain other features of the omnidirectional lamp 100. FIG. 5 highlights an approach to coupling light sources to a substrate of the omnidirectional lamp 100. FIG. 6 is a diagram showing various views of the omnidirectional lamp 100. The following description refers to FIGS. 1-6.

As shown in FIGS. 1 and 2, the omnidirectional lamp 100 includes a light-emission module 120. The light-emission module 120 includes a substrate 124 and at least one first light source 121 and at least one second light source 122. One or more of the at least one first light source 121 and the at least one second light source 122 may be, for example, LEDs. The substrate 124 may be, for example, a FR4 circuit board or a ceramic board. The substrate 124 includes a first primary surface (e.g., the top surface shown in FIGS. 1 and 2). The first primary surface of the substrate 124 defines a first horizontal plane that is substantially perpendicular to a longitudinal axis of the omnidirectional lamp 100. The at least one first light source 121 and the at least one second light source 122 are disposed on the first primary surface of the substrate 124. The substrate 124 may further comprise a second primary surface (e.g., the bottom surface shown in FIGS. 1 and 2) which is opposite to the first primary surface.

As shown in FIG. 2, each of the at least one first light source 121 has a non-adjustable light-emitting surface 121a and each of the at least one second light source 122 has an adjustable light-emitting surface 122a. That is, the light-emitting surface 122a of each of the at least one second light source 122 is at an individually adjustable angle with respect to the first horizontal plane. Thus, light emitted by each of the at least one second light source 122 may be emitted toward a respective angle that is adjustable according to a given need for illumination. For example, the angle of the light-emitting surface 122a of one or more of the at least one second light source 122 may be approximately between 120 and 150 degrees with respect to the first horizontal plane of substrate 124. In this case, the one or more of the at least one second light source 122 would be downward-emitting as the emitted light would generally be pointed downwardly with respect to omnidirectional lamp 100. Alternatively or additionally, the angle of the light-emitting surface 122a of one or more of the at least one second light source 122 may be approximately 90 degrees with respect to the first horizontal plane of substrate 124. In this case, the one or more of the at least one second light source 122 would be side-emitting as the emitted light would generally be pointed toward the side of omnidirectional lamp 100. Still alternatively or additionally, the angle of the light-emitting surface 122a of one or more of the at least one second light source 122 may be approximately 0 degree with respect to the first horizontal plane of substrate 124, i.e., parallel to the first horizontal plane. In this case, the one or more of the at least one second light source 122 would be upward-emitting as the emitted light would generally be pointed toward the top of omnidirectional lamp 100. Therefore, with sufficient number of second light sources 122 and with the angles of the light-emitting surfaces 122a of the second light sources 122 set properly, light emitted by light-emission module 120 may be compliant with requirements of the ENERGY STAR program with respect to intensity and uniformity of light emitted by an A60 light bulb.

As the light-emitting surface 122a of each of the at least one second light sources 122 is adjustable, so is a ratio of a first number of the at least one first light source 121, each of which having a respective light-emitting surface 121a at an angle of approximately 0 degree with respect to the first horizontal plane of substrate 124 (e.g., upward-emitting), to a second number of the at least one second light source 122, each of which having the respective light-emitting surface 122a at an angle greater than 0 degree with respect to the first horizontal plane of substrate 124 (e.g. side-emitting). That is, such ratio is adjustable. For example, this ratio may be in a range between 0.3 and 0.6 approximately.

In some embodiments, the omnidirectional lamp 100 may further include a heat-dissipation module 130 that is made of a heat-conductive material such as, for example, aluminum or copper. The heat-dissipation module 130 may include a finned portion 134 and a platform portion 132 that protrudes from the finned portion 134 along the longitudinal axis of omnidirectional lamp 100. The platform portion 132 may include a mounting surface 132a on which the second primary surface of the substrate 124 of the light-emission module 120 is mounted. For example, the light-emission module 120 may be fastened, mounted or otherwise secured to the heat-dissipation module 130 by one or more screws 115. Thus, at least some of the heat generated by the at least one first light source 121 and the at least one second light source 122 may be conducted or otherwise transferred to heat-dissipation module 130 through substrate 124.

In some embodiments, the omnidirectional lamp 100 may further include a light-transmissive module 110, a drive circuit module 140, a holder 150 and a power connection module 160. The light-transmissive module 110 may be disposed on a first end (e.g., top end) of the heat-dissipation module 130 to contain the light-emission module 120 therein. The light-transmissive module 110 may be configured to provide a light diffusion effect for light emitted by the light-emission module, and may be made of a plastic material such as, for example, polycarbonate (PC) or poly(methyl methacrylate) (PMMA). The light-transmissive module 110 may be a lens, and may be a one-piece design or a two-piece design. In the case of two-piece design, the light-transmissive module 110 would include two halves fastened or otherwise affixed together with one of the halves having an opening to accommodate the light-emission module 120.

The drive circuit module 140 may be coupled to a second end (e.g., bottom end) of the heat-dissipation module 130 which is opposite to the first end thereof. The drive circuit module 140 may include a drive circuit board with circuitry configured to convert an AC electricity to a DC electricity to power the light-emission module 120. The holder 150 may be configured to contain the drive circuit board 140 therein to electrically insulate the drive circuit board 140 from external contacts and environmental elements. The holder 150 may be made of a plastic material such as, for example, PC, acrylonitrile butadiene styrene (ABS), polybutylene terephthalate (PBT), or a combination of PC and ABS. The holder 150 may be fastened, mounted or otherwise secured to the heat-dissipation module 130 by one or more screws 125.

The power connection module 160, as a base of the omnidirectional lamp 100, may be coupled to the drive circuit module 140. The power connection module 160 may be configured to receive the AC electricity from an external power supply. The drive circuit module 140 may include electrical terminals that electrically connect the drive circuit module 140 to the external power supply via the power connection module 160, and may be made of electrically-conductive material such as metal.

Referring to FIG. 3, in some embodiments, the at least one first light source 121 and the at least one second light source 122 are disposed along the periphery of the substrate 124 to form a ring of light sources. Spacing between the light sources (including the at least one light source 121 and the at least one second light source 122) and the light-transmissive module 110 is no less than a minimum distance because spots of light of relatively higher brightness would form on the light-transmissive module 110 if the at least one first light source 121 and the at least one second light source 122 are too close to the light-transmissive module 110. On the other hand, spacing between the light sources (including the at least one light source 121 and the at least one second light source 122) and the light-transmissive module 110 is no greater than a maximum distance in consideration of two factors: (1) to avoid excessive amount of the light emitted by the at least one second light source 122 being blocked by the heat-dissipation module 130; and (2) to maintain the number of at least one light source 121 and the at least one second light source 122 no less than a minimum number required to provide sufficient illumination and avoid spots of light of relatively higher brightness forming on the light-transmissive module 110. In the example shown in FIG. 3, the spacing, or the shortest distance, between the at least one light source 121 and the at least one second light source 122 and the light-transmissive module 110 is 13 millimeters (mm).

Referring to FIG. 4, in some embodiments, a height or height of the platform portion 132 of the heat-dissipation module 130 between the finned portion 134 and the mounting surface 132a may be approximately between 10 and 30 mm. This feature also helps minimize the light emitted by the at least one second light source 122 from being blocked by the fins of the heat-dissipation module 130.

FIG. 5 highlights an approach to coupling light sources to a substrate of the omnidirectional lamp 100. The conventional approach as illustrated in FIG. 5B is more labor intensive during manufacturing and costs more due to more raw materials required. In the conventional approach, a metallic substrate 524 is typically used as the substrate on which light sources, e.g., LEDs, are mounted or otherwise disposed. This approach, however, typically requires structures such as a top cover 522 and a bridge 526 in order to comply with electrical safety regulations. In contrast, as shown in FIG. 5A, the substrate of the omnidirectional lamp 100 of the present disclosure may be a FR4 circuit board. Accordingly, power output pins of the drive circuit module 140 and power input pads of the substrate 124 of the light-emission module 120 may be directly soldered with direct soldering 514 during assembly without issues with respect to electrical safety regulations. This approach advantageously reduces the amount of time and raw materials required for assembly.

FIG. 6 shows various views of the omnidirectional lamp 100. In some embodiments, light emitted by the light-emission module 120 of omnidirectional lamp 100 is compliant with requirements of ENERGY STAR program with respect to intensity and uniformity of light emitted by an A60 light bulb. Further, in some embodiments, the omnidirectional lamp 100 is compliant with the ANSI requirements at least in terms of size and form factor.

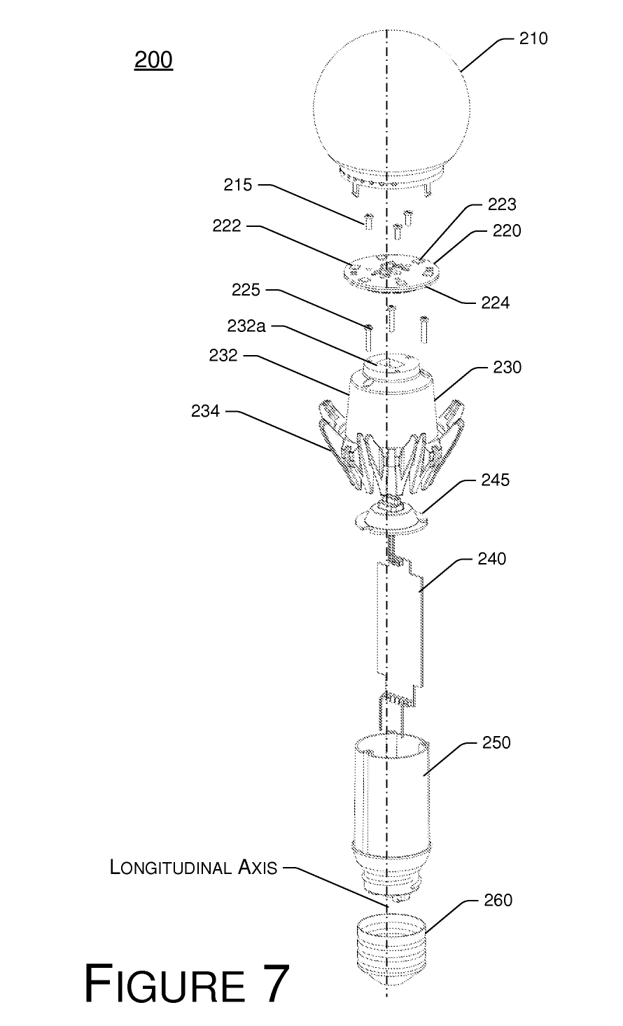

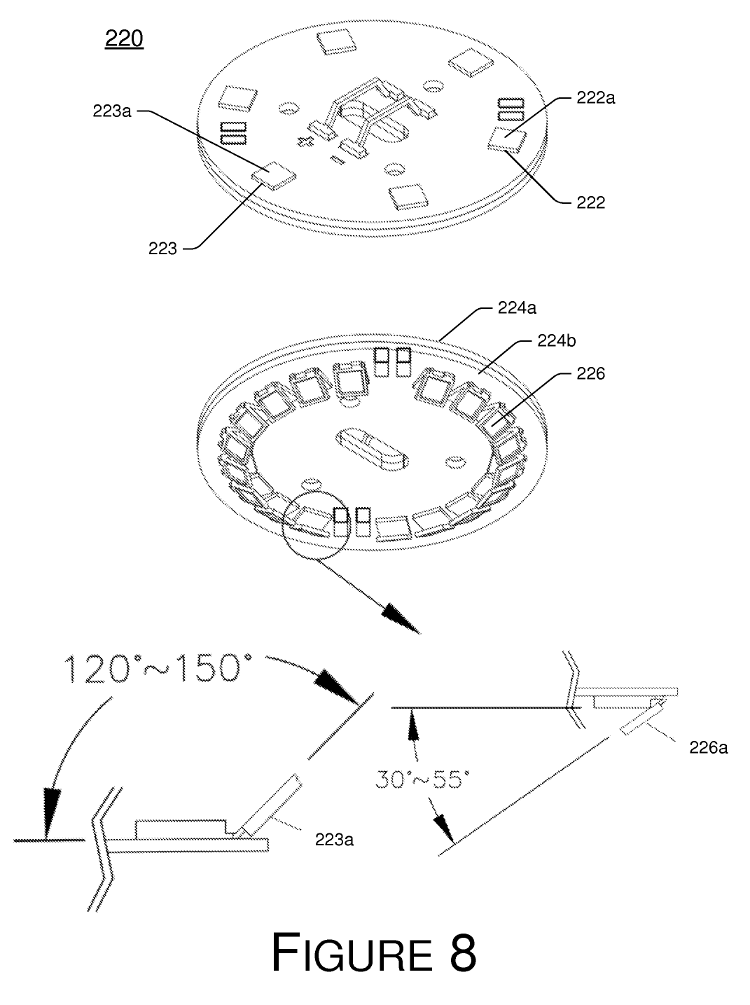

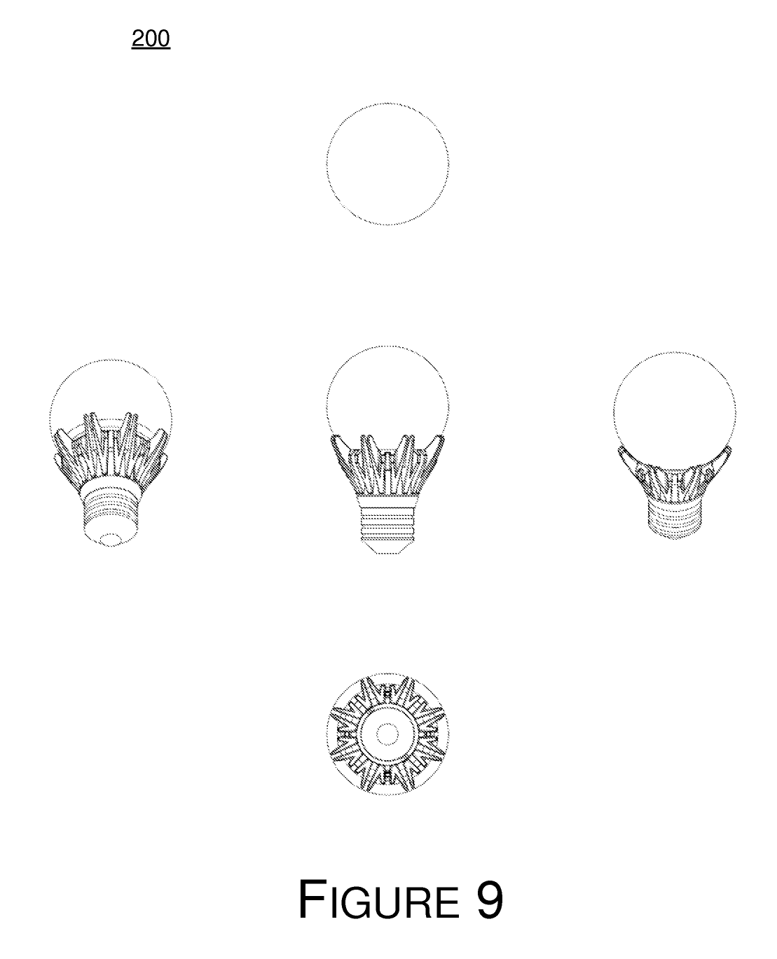

FIG. 7 is an exploded view of an omnidirectional lamp 200 in accordance with another embodiment of the present disclosure. FIG. 8 is an embodiment of a light-emission module of the omnidirectional lamp 200. FIG. 9 is a diagram showing various views of the omnidirectional lamp 200. The following description refers to FIGS. 7-9. As certain features of omnidirectional lamp 200 are similar or identical to corresponding features of omnidirectional lamp 100, in the interest of brevity a detailed description of those features will not be repeated. Thus, although not repeated below, any feature described above with respect to omnidirectional lamp 100 and not repeated below also applies to omnidirectional lamp 200.

As shown in FIGS. 7 and 8, the omnidirectional lamp 200 includes a light-emission module 220. The light-emission module 220 includes a substrate 224, at least one first light source 222, at least one second light source 226. Optionally, the light-emission module 220 may further include at least one third light source 223. The substrate 224 includes a first primary surface (e.g., top surface) and a second primary surface (e.g., bottom surface) which is opposite to the first primary surface. The first primary surface of the substrate 224 defines a first horizontal plane that is substantially perpendicular to a longitudinal axis of omnidirectional lamp 200. The second primary surface of the substrate 224 defines a second horizontal plane that is substantially perpendicular to the longitudinal axis of omnidirectional lamp 200.

The at least one first light source 222 and the at least one third light source 223 are disposed on the first primary surface of the substrate 224. Each of the at least one first light source 222 has a non-adjustable light-emitting surface 222a. As with the at least one second light source 122 of the omnidirectional lamp 100, each of the at least one third light source 223 has an adjustable light-emitting surface 223a. That is, the light-emitting surface 223a of each of the at least one third light source 223 is at an individually adjustable angle with respect to the first horizontal plane of substrate 224. The at least one second light source 226 is disposed on the second primary surface of the substrate 224. As with the at least one third light source 223, each of the at least one second light source 226 has an adjustable light-emitting surface 226a. That is, the light-emitting surface 226a of each of the at least one second light source 226 is at an individually adjustable angle with respect to the second horizontal plane of substrate 224.

In some embodiments, a quantity of the at least one third light source 223 may be six (6), and a quantity of the at least one second light source 226 may be eighteen (18). In some embodiments, the angle of the light-emitting surface 223a of one or more of the at least one third light source 223 may be approximately 0 degree with respect to the first horizontal plane of substrate 224 (e.g., parallel to the first horizontal plane), and the angle of the light-emitting surface 226a of one or more of the at least one second light source 226 may be approximately between 30 and 55 degrees with respect to the second horizontal plane of substrate 224. The second primary surface of the substrate 224 faces toward a base of the omnidirectional lamp 200. In this configuration, one or more of the at least one third light source 223, along with the at least one first light source 222, would be upward-emitting while one or more of the at least one second light source 226 would be side-emitting and/or downward-emitting.

Alternatively or additionally, the angle of the light-emitting surface 223a of one or more of the at least one third light source 223 may be approximately 0 degree with respect to the first horizontal plane, and the angle of the light-emitting surface 226a of one or more of the at least one second light source 226 may be greater than 0 degree with respect to the second horizontal plane. Still alternatively or additionally, the angle of the light-emitting surface 223a of one or more of the at least one third light source 223 may be greater than 0 degree with respect to the first horizontal plane, and the angle of the light-emitting surface 226a of one or more of the at least one second light source 226 may be approximately 0 degree with respect to the second horizontal plane.

In some embodiments, there are a quantity of sixteen (16) of the first and third light sources 222 and 223 disposed on the first primary surface of substrate 224 and a quantity of sixteen (16) of the second light sources 226 disposed on the second primary surface of substrate 224. In one embodiment, there may be six (6) first light sources 222 emitting toward the top of omnidirectional lamp 200 (e.g., the light-emitting surface 222a of each first light source 222 is substantially parallel to the first horizontal surface) while there may be ten (10) third light sources 223 emitting toward the side of omnidirectional lamp 200 (e.g., the light-emitting surface 223a of each is substantially perpendicular to the first horizontal surface), with the sixteen (16) second light sources 226 emitting toward the bottom of omnidirectional lamp 200 (e.g., the light-emitting surface 226a of each is substantially parallel to the second horizontal surface). Alternatively, there may be four first light sources 222 emitting toward the top of omnidirectional lamp 200 (e.g., the light-emitting surface 222a of each is substantially parallel to the first horizontal surface) while there may be twelve (12) third light sources 223 emitting toward the side of omnidirectional lamp 200 (e.g., the light-emitting surface 223a of each is substantially perpendicular to the first horizontal surface), with the sixteen (16) second light sources 226 emitting toward the bottom of omnidirectional lamp 200 (e.g., the light-emitting surface 226a of each is substantially parallel to the second horizontal surface). In other embodiments, there are different combinations of different quantities of the at least one first light source 222 and the at least one third light source 223 disposed on the first primary surface of substrate 224, and different quantities of the at least second light source 226 disposed on the second primary surface of substrate 224.

As shown in FIG. 8, the substrate 224 may include a first circuit board 224a and a second circuit board 224b. The first circuit board 224a may include the first primary surface on which the at least one first light source 222 and the at least one third light source 223 are disposed. The second circuit board 224b may include the second primary surface on which the at least one second light source 226 is disposed. The first and second circuit boards 224a and 224b may be electrically coupled to each other. Each of the first and second circuit boards 224a and 224b may be a FR4 circuit board or a ceramic board.

In some embodiments, the omnidirectional lamp 200 may further include a heat-dissipation module 230 that is made of a heat-conductive material such as, for example, aluminum or copper. The heat-dissipation module 230 may include a finned portion 234 and a platform portion 232 that protrudes from the finned portion 234 along the longitudinal axis of omnidirectional lamp 200. The platform portion 232 may include a mounting surface 232a on which the second primary surface of the substrate 224 of the light-emission module 220 is mounted. For example, the light-emission module 220 may be fastened, mounted or otherwise secured to the heat-dissipation module 230 by one or more screws 215. Thus, at least some of the heat generated by the at least one first light source 222, the at least one third light source 223 and the at least one second light source 226 may be conducted or otherwise transferred to heat-dissipation module 230 through substrate 224.

In some embodiments, the omnidirectional lamp 200 may further include a light-transmissive module 210, a drive circuit module 240, a cover 245, a holder 250 and a power connection module 260. The light-transmissive module 210 may be disposed on a first end (e.g., top end) of the heat-dissipation module 230 to contain the light-emission module 220 therein. The light-transmissive module 210 may be configured to provide a light diffusion effect for light emitted by the light-emission module, and may be made of a plastic material such as, for example, PC or PMMA. The light-transmissive module 210 may be a lens, and may be a one-piece design or a two-piece design. In the case of two-piece design, the light-transmissive module 210 would include two halves fastened or otherwise affixed together with one of the halves having an opening to accommodate the light-emission module 220.

The drive circuit module 240 may be coupled to a second end (e.g., bottom end) of the heat-dissipation module 230 which is opposite to the first end thereof. The drive circuit module 240 may include a drive circuit board with circuitry configured to convert an AC electricity to a DC electricity to power the light-emission module 220. The holder 250 may be configured to contain the drive circuit board 240 therein to electrically insulate the drive circuit board 240 from external contacts and environmental elements. The holder 250 may be made of a plastic material such as, for example, PC, ABS, PBT, or a combination of PC and ABS. The holder 250 may be fastened, mounted or otherwise secured to the heat-dissipation module 230 by one or more screws 225. The cover 245 may be configured to conceal the drive circuit module 240 together with the holder 250 to satisfy electrical regulations. The cover 245 may be made of a plastic material such as, for example, PC, ABS, PBT or a combination of PC and ABS.

The power connection module 260, as a base of the omnidirectional lamp 200, may be coupled to the drive circuit module 240. The power connection module 260 may be configured to receive the AC electricity from an external power supply. The drive circuit module 240 may include electrical terminals that electrically connect the drive circuit module 240 to the external power supply via the power connection module 260, and may be made of electrically-conductive material such as metal.

FIG. 9 shows various views of the omnidirectional lamp 200. In some embodiments, light emitted by the light-emission module 220 of omnidirectional lamp 200 is compliant with requirements of ENERGY STAR program with respect to intensity and uniformity of light emitted by an A60 light bulb. Further, in some embodiments, the omnidirectional lamp 200 is compliant with the ANSI requirements at least in terms of size and form factor.

### Additional Notes

Embodiments of a lamp that produces omnidirectional light in accordance with the present disclosure are not limited to those described herein. The actual design and implementation of each component of the luminaire or the power supply module in accordance with the present disclosure may vary from the embodiments described herein. Those ordinarily skilled in the art may make various deviations and improvements based on the disclosed embodiments, and such deviations and improvements are still within the scope of the present disclosure. Accordingly, the scope of protection of a patent issued from the present disclosure is determined by the claims as follows.

In the above description of exemplary implementations, for purposes of explanation, specific numbers, materials configurations, and other details are set forth in order to better explain the present disclosure, as claimed. However, it will be apparent to one skilled in the art that the claimed subject matter may be practiced using different details than the exemplary ones described herein. In other instances, well-known features are omitted or simplified to clarify the description of the exemplary implementations.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

For the purposes of this disclosure and the claims that follow, the terms “coupled” and “connected” may have been used to describe how various elements interface. Such described interfacing of various elements may be either direct or indirect.

What is claimed is:

1. A lamp, comprising:
a light-emission module, comprising:
a substrate having a first primary surface defining a first horizontal plane that is substantially perpendicular to a longitudinal axis of the lamp; and
at least one first light source and at least one second light source disposed on the first primary surface of the substrate, the at least one second light source having a light-emitting surface at an individually adjustable angle with respect to the first horizontal plane.

2. The lamp of claim 1, wherein the angle of the light-emitting surface of the at least one second light source is approximately between 120 and 150 degrees or approximately 90 degrees with respect to the first horizontal plane.

3. The lamp of claim 1, wherein the angle of the light-emitting surface of the at least one first light source is non-adjustable and is approximately 0 degree with respect to the first horizontal plane.

4. The lamp of claim 1, wherein a ratio of a number of the at least one first light source to a number of the at least one second light source is adjustable, and wherein the ratio is in a range between 0.3 and 0.6 approximately.

5. The lamp of claim 1, wherein the substrate may further include a second primary surface opposite to the first primary surface and defining a second horizontal plane that is substantially perpendicular to the longitudinal axis of the lamp, and wherein the light-emission module further comprises at least one third light source disposed on the second primary surface of the substrate, the at least one third light source having a light-emitting surface at an individually adjustable angle with respect to the second horizontal plane.

6. The lamp of claim 1, wherein one or more of the at least one first light source and the at least one second light source comprise a light-emitting diode (LED).

7. The lamp of claim 1, further comprising:
a heat-dissipation module, comprising:
a finned portion; and
a platform portion protruding from the finned portion along the longitudinal axis of the lamp, the platform portion having a mounting surface on which a second primary surface of the substrate of the light-emission module opposite to the first primary surface is mounted.

8. The lamp of claim 7, wherein a height of the platform portion of the heat-dissipation module between the finned portion and the mounting surface is approximately between 10 and 30 mm.

9. The lamp of claim 7, further comprising:
a light-transmissive module disposed on a first end of the heat-dissipation module to contain the light-emission module therein, the light-transmissive module configured to provide a light diffusion effect for light emitted by the light-emission module;
a drive circuit module coupled to a second end of the heat-dissipation module opposite to the first end thereof, the drive circuit module configured to convert an AC electricity to a DC electricity to power the light-emission module; and
a power connection module as a base of the lamp and coupled to the drive circuit module, the power connection module configured to receive the AC electricity from an external power supply.

10. The lamp of claim 9, wherein light emitted by the light-emission module is compliant with requirements of ENERGY STAR program with respect to intensity and uniformity of light emitted by an A60 light bulb, and wherein the lamp is compliant with American National Standards Institute (ANSI) requirements at least in terms of size and form factor.

11. A lamp, comprising:
a light-emission module, comprising:
a substrate having a first primary surface and a second primary surface opposite to the first primary surface, the first primary surface of the substrate defining a first horizontal plane that is substantially perpendicular to a longitudinal axis of the lamp, the second primary surface of the substrate defining a second horizontal plane that is substantially perpendicular to the longitudinal axis of the lamp;
at least one first light source disposed on the first primary surface of the substrate, the at least one first light source having a light-emitting surface at a non-adjustable angle with respect to the first horizontal plane; and
at least one second light source disposed on the second primary surface of the substrate, the at least one second light source having a light-emitting surface at an individually adjustable angle with respect to the second horizontal plane, wherein the angle of the light-emitting surface of the at least one second light source is greater than 0 degree with respect to the second horizontal plane.

12. The lamp of claim 11, wherein a quantity of the at least one first light source is six, and wherein a quantity of the at least one second light source is eighteen.

13. The lamp of claim 11, wherein the light-emission module further comprises at least one third light source disposed on the first primary surface of the substrate and having a light-emitting surface at an individually adjustable angle with respect to the first horizontal plane.

14. The lamp of claim 11, further comprising:
a heat-dissipation module, comprising:
a finned portion; and
a platform portion protruding from the finned portion along the longitudinal axis of the lamp, the platform portion having a mounting surface on which the second primary surface of the substrate of the light-emission module is mounted,
wherein a height of the platform portion of the heat-dissipation module between the finned portion and the mounting surface is approximately between 10 and 30 mm.

15. The lamp of claim 11, wherein the substrate comprises:
a first circuit board having the first primary surface on which the at least one first light source are disposed; and
a second circuit board having the second primary surface on which the at least one second light source are disposed,
wherein the first and second circuit boards are electrically coupled to each other.

16. A lamp, comprising:
a light-emission module, comprising:
a substrate having a first primary surface and a second primary surface opposite to the first primary surface, the first primary surface of the substrate defining a first horizontal plane that is substantially perpendicular to a longitudinal axis of the lamp;
at least one first light source disposed on the first primary surface of the substrate, the at least one first light source having a light-emitting surface at an individually adjustable angle with respect to the first horizontal plane; and
at least one second light source disposed on the second primary surface of the substrate, the second primary surface of the substrate defining a second horizontal plane that is substantially perpendicular to the longitudinal axis of the lamp, the at least one second light source having a light-emitting surface at an individually adjustable angle with respect to the second horizontal plane; and
a heat-dissipation module, comprising:
a finned portion; and
a platform portion protruding from the finned portion along the longitudinal axis of the lamp, the platform portion having a mounting surface on which the second primary surface of the substrate of the light-emission module is mounted.

17. The lamp of claim 16, wherein the substrate comprises:
a first circuit board having the first primary surface on which the at least one first light source is disposed; and
a second circuit board having the second primary surface on which the at least one second light source is disposed,
wherein the first and second circuit boards are electrically coupled to each other.

18. The lamp of claim 16, wherein the angle of the light-emitting surface of the at least one first light source is approximately 0 degree with respect to the first horizontal plane, and wherein the angle of the light-emitting surface of the at least one second light source is approximately between 30 and 55 degrees with respect to the second horizontal plane.

19. The lamp of claim 16, further comprising:
a light-transmissive module disposed on a first end of the heat-dissipation module to contain the light-emission module therein, the light-transmissive module configured to provide a light diffusion effect for light emitted by the light-emission module;
a drive circuit module coupled to a second end of the heat-dissipation module opposite to the first end thereof, the drive circuit module configured to convert an AC electricity to a DC electricity to power the light-emission module; and
a power connection module as a base of the lamp and coupled to the drive circuit module, the power connection module configured to receive the AC electricity from an external power supply,
wherein a height of the platform portion of the heat-dissipation module between the finned portion and the mounting surface is approximately between 10 and 30 mm.

20. The lamp of claim 19, wherein at least one of the light sources comprises a light-emitting diode (LED), wherein light emitted by the light-emission module is compliant with requirements of ENERGY STAR program with respect to intensity and uniformity of light emitted by an A60 light bulb, and wherein the lamp is compliant with American National Standards Institute (ANSI) requirements at least in terms of size and form factor.
